(19) United States
(12) Patent Application Publication
(10) Pub. No.: US 2016/0088367 A1
(43) Pub. Date: Mar. 24, 2016

(54) PROGRAM EVENT DETECTION METHOD, APPARATUS, AND PROGRAM DATA TRANSMISSION SYSTEM

(71) Applicant: INSTITUTE FOR INFORMATION INDUSTRY, Taipei City (TW)

(72) Inventors: WENSHAN LIOU, NEW TAIPEI CITY (TW); YU HAO CHEN, TAIPEI CITY (TW)

(21) Appl. No.: 14/596,651

(22) Filed: Jan. 14, 2015

(30) Foreign Application Priority Data
Sep. 19, 2014 (TW) 103132469

(51) Int. Cl. H04N 21/845; H04N 21/234; H04N 21/233; H04H 60/59; H04H 60/40; H04H 60/41; H04H 60/58; H04N 21/8358; H04H 60/37

(52) U.S. Cl. CPC H04N 21/8456; H04N 21/8358; H04N 21/23418; H04N 21/233; H04H 60/37; H04H 60/40; H04H 60/41; H04H 60/58; H04H 60/59

(57) ABSTRACT

An exemplary embodiment of the present disclosure illustrates a program event detection method mainly executed in a server of a service provider end. Features of frontend parts of program segments are detected. Original times of the program segments corresponding to the detected features are obtained. A relation between the original times and program displaying times of the program segments is determined according to the original times and the program displaying times. A program event and a program event time thereof based on original times are received. According to a real broadcasting time, the program event time, and the relation between the original times and program displaying times, a real program event time is calculated. At the real program event time, the program event is transmitted to a networking device of a client end.

### BACKGROUND

1. Technical Field

The present disclosure relates to program data transmission system, in particular, to a program data transmission system using the program event detection method or apparatus which can calculate the relation between original times and program displaying times of the program segments, obtain the real program event time corresponding to the program event time accordingly, and transmit the program event to the client end at the real program event time.

2. Description of Related Art

With the fast development of the internet and communication technology, the combination of the television and the network is getting compact. To make the program story be interact with the client end, or to increase the desire of the client end for watching the program, or even to increase the advertisement income of the program, the program maker end usually transmits a program end to a client end when the program is displayed at a specific time, wherein the program event may be a quiz contest, a competition show person/ group vote, a product sale information, or the other similar event.

For the program maker end, program event time is marked on a time axis of the original program. The original program of the program maker end is transmitted to the television station end, and the television station end determines the program displaying times and inserts the advertisements between the program segments of the original program. Thus, the program event time is altered due to the inserted advertisements by the program maker end. On the other hand, the later the program event and the program event time are determined, the higher the business value is. Since, the program events may be an advertisement event, and the charges of the advertisement events are usually dependent on the ratings of the program, the program maker end may need to wait for an appropriate price of advertisements without determining the program event early.

U.S. Pat. No. 7,634,798 discloses a method and a system for an interacting and broadcasting television, which can mark the program event based on the time axis of the original program, and transmit the program event at the program event time while the program is displayed. However, U.S. Pat. No. 7,634,798 does not consider that the program time is influenced by the inserted advertisements, and can be merely used in program data transmission system lacking of inserted advertisement.

In addition, U.S. Pat. No. 7,478,240 disclose a method and system for retrieving a related information of a specific media and a delivering time, which can embed the watermark with the program event information into the program, and present the program event to the client end by detecting and analyzing the watermark of the program after the program is displayed. U.S. Pat. No. 7,478,240 must embed the watermark at the program event time point of the program, and determine the program event and the program event time early. Thus, while the program event is the advertisement event, the business value of the program event may be lowered.

### SUMMARY

An exemplary embodiment of the present disclosure provides a program event detection method mainly executed in a server of a service provider end. The program event detection method comprises steps as follows. Features of frontend parts associated with program segments in a program data are detected. Original times of the program segments corresponding to the features from a feature database are obtained. According to the original times of the program segments and program displaying times of the program segments, a relation between the original times of the program segments and the program displaying times of the program segments is determined. A program event and a program event time of the program event based on the original times of the program segments are received. According to a real broadcasting time of the program data, the program event time, and the relation between the original times of the program segments and the program displaying times of the program segments, a real program event time of the program event is calculated. At the real program event time, the program event is transmitted to a networking device of a client end.

An exemplary embodiment of the present disclosure provides a program event detection apparatus comprising a feature detection module, a program time calculation module, and an event notification module, wherein the program time calculation module is electrically connected to the feature detection module, and the event notification module is electrically connected to the program time calculation module. The feature detection module is used to detect features of frontend parts associated with program segments in a program data, and obtain original times of the program segments corresponding to the features from a feature database. The program time calculation module is used to receive a program event and a program event time based on the original times of the program segments, determine a relation between the original times of the program segments and the program displaying times of the program segments according to the original times of the program segments and program displaying times of the program segments, and calculate a real program event time of the program event according to a real broadcasting time of the program data, the program event time, and the relation between the original times of the program segments and the program displaying times of the program segments. The event notification module is used to transmit the program event to a networking device of a client end at the real program event time.

An exemplary embodiment of the present disclosure provides a program data transmission system comprising servers of a program maker end, a television station end, and a service provider end, wherein the server of the television station end is linked to the server of the program maker end, and the server of the service provider end is linked to the servers of the program maker end and the television station end. The server of the program maker end is used to determine a program event and a program event time, and record the program event and the program event time in an event database before a real broadcasting time of a program data reaches. The server of a television station end is used to receive the program data having the program segments from the program maker end, insert advertisements between the program segments, determine a real broadcasting time and a channel of the program data, and record the program data in the program database. The server of a service provider end is used to detect features of frontend parts associated with the program segments in the program data, obtain original times of the program segments corresponding to the features from a feature database, determine a relation between the original times of the program segments and the program displaying times of the program segments according to the original times of the program segments and program displaying times of the program segments, receive a program event and a program event time based on the original times of the program segment, calculate a real program event time of the program event according to a real broadcasting time of the program data, the program event time, and the relation between the original times of the program segments and the program displaying times of the program segments, and transmit the program event to a networking device of a client end at the real program event time. The server of the program maker end or the television station end is further used to determine the features of the frontend parts associated with the program segments, and record a relation between the features and the program segments in a feature database.

To sum up, the program event detection method, apparatus, and the program data transmission system provided by exemplary embodiments of the present disclosure can make the program event time based on the original times be not influenced by the inserted advertisements, and further let the not to determine the program event and program event time early, such that the business value of the program event can be increased.

In order to further understand the techniques, means and effects of the present disclosure, the following detailed descriptions and appended drawings are hereby referred, such that, through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 is a schematic diagram showing time axes of an original program associated with a program maker end, a program with inserted advertisements associated of a television station end, and a program with frontend parts of program segments marked with features according to an exemplary embodiment of the present disclosure.

FIG. 2 is a schematic diagram showing system architecture of a program data transmission system according to an exemplary embodiment of the present disclosure.

FIG. 3 is a flow chart of a program event detection method according to an exemplary embodiment of the present disclosure.

FIG. 4A is a block diagram of a server of a program maker end for implementing the program event detection method of FIG. 3.

FIG. 4B is a block diagram of a server of a television station end for implementing the program event detection method of FIG. 3.

FIG. 4C is a block diagram of a server of a service provider end for implementing the program event detection method of FIG. 3.

FIG. 5 is a flow chart of a program event detection method according to another one exemplary embodiment of the present disclosure.

FIG. 6A is a block diagram of a server of a program maker end for implementing the program event detection method of FIG. 5.

FIG. 6B is a block diagram of a server of a television station end for implementing the program event detection method of FIG. 5.

FIG. 6C is a block diagram of a server of a service provider end for implementing the program event detection method of FIG. 5.

### DESCRIPTION OF THE EXEMPLARY EMBODIMENTS

Reference will now be made in detail to the exemplary embodiments of the present disclosure, examples of which are illustrated in the accompanying drawings. Wherever possible, the same reference numbers are used in the drawings and the description to refer to the same or like parts.

Exemplary embodiment of the present disclosure provides a program event detection method and apparatus, and further provides a program data transmission system using the program event detection method or apparatus. The program event detection method and apparatus can detect the frontend parts of the program segments of the program with inserted advertisements, calculate a relation between original times and program displaying times of the detected program segments according to the original times and the program displaying times of the detected program segments, and then calculate a real program event time corresponding to the program event accordingly. Next, the program event detection method and apparatus transmit the program event to the client end at the above calculated real program event time.

In addition, to implement a detection of the frontend parts of the program segments, features of the frontend parts associated with the program segments are detected. The features of the frontend parts associated with the program segments can be digital watermarks embedded therein or audio fingerprints thereof. However, the present disclosure does not limit the kinds of the features of the frontend parts associated with the program segments.

Specifically, in one exemplary embodiment of the present disclosure, the television station end or the program maker end can embed the digital watermarks in the frontend parts of the program segments, and record the relation between the digital watermarks and the program segments in the feature database. After the program event detection method and apparatus detects the digital watermarks of the frontend parts associated with the program segments, the program event detection method and apparatus can find how the detected digital watermarks correspond to the program segments by querying the feature database.

In another one exemplary embodiment of the present disclosure, the television station end or the program maker end can obtain the audio fingerprints of the frontend parts associated with the program segments, and record the relation between the audio fingerprints and the program segments in the feature database. After the program event detection method and apparatus detects the audio fingerprints of the frontend parts associated with the program segments, the program event detection method and apparatus can find how the detected audio fingerprints correspond to the program segments by querying the feature database.

In short, by using the program event detection method or apparatus, the inserted advertisements cannot influence the program event time. In addition, the program maker end does not determine the program event and the program event time early, but merely records the relation between the features of the frontend parts associated with the program segments and the program segments, thus increasing the business value of the program event.

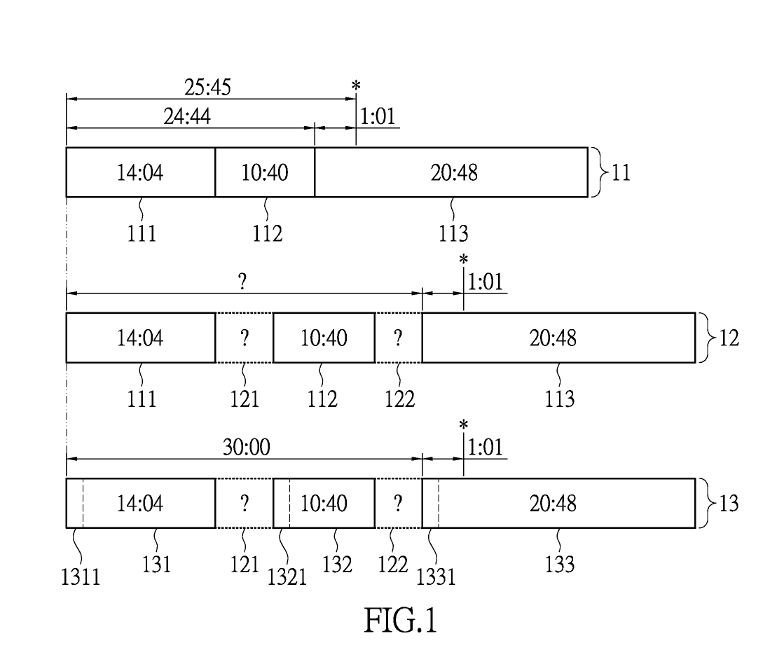

Referring to FIG. 1, FIG. 1 is a schematic diagram showing time axes of an original program associated with a program maker end, a program with inserted advertisements associated of a television station end, and a program which frontend parts of program segments are marked with features or the features of frontend parts associated with the program segments are extracted according to an exemplary embodiment of the present disclosure. In FIG. 1, the original program 11 made by the program maker end is segmented into program segments 111 through 113, i.e. the original program 11 comprises program segments 111 through 113. The total length of the time axis of the original program 11 is 45:32 (i.e. 45 minutes plus 32 seconds), and the lengths of the program segments 111 through 113 are respectively 14:04, 10:40, and 20:48. The program maker end marks the program event on the time axis, for example, the program event is marked at the point of 25:45 on the time axis with a star label in FIG. 1. The total length of the program segments 111 and 112 is 24:44, and thus it can be known that after the program segment 113 has been displayed for 1:1, the program event occurs.

The television station end inserts the advertisements 121 and 122 between the program segments 111 through 113 to form a program 12 with inserted advertisements 121 and 122. The program maker end does not know the lengths of the advertisements 121 and 122 inserted by the television station end, and thus as the description of the related art, the inserted advertisements 121 and 122 influence the program event time, such that the program maker end cannot transmit the program event to the client end at the correct real program event time corresponding to the program event time. The program maker end knows the lengths of the program segments 111 through 113, and the program maker end or the television station end may mark features on the frontend parts of the program segments 111 through 113, or alternatively, extract the features of frontend parts associated with the program segments 111 through 113, such that the service provider end can know the current displayed program segment by detecting the features of the program segments 111 through 113, and transmit the transmit the program event to the client end at the correct real program event time.

The program 13 which the features is marked in the frontend parts of the program segments or the features of frontend parts associated with the program segments are extracted comprises program segments 131 through 133 and advertisements 121 and 122. The digital watermarks are embedded into the frontend parts of the program segments 111 through 113 to mark the features on the frontend parts of the program segments 111 through 113. Since the frontend parts 1311, 1321, and 1331 of the program segments 131 through 133 have the digital watermarks therein, the program segments 111 through 113 may not be the same as the program segments 131 through 133. That is, the digital watermarks are embedded into the frontend parts of the program segments 111 through 113 to form the program segments 131 through 133.

In addition, the audio fingerprints of the frontend parts associated with the program segments 111-113 are extracted to extract the features of frontend parts associated with the program segments 111-113. Meanwhile, the frontend parts of the program segments 111-113 are not modified, and thus the program segments 111 through 113 are the same as the program segments 131 through 133. That is, the frontend parts of the program segments 111 through 113 are the same as the frontend parts 1311, 1321, and 1331 of the program segments 131 through 133.

For example, the service provider end can detect the features of the frontend part 1331 associated with the program segment 133 to know the current displayed program segment is the program segment 133. Then, according to the total length (24:44) of the program segments 111 and 112 and the program displaying time (30:00) of the program segment 113, a relation between the original time (24:44) of the program segment 113 and the program displaying time (30:00) of the program segment 113 can be obtained, and then according to the relation between the original time (24:44) of the program segment 113 and the program displaying time (30:00) of the program segment 113, the real program event time corresponding to the program event time can be calculated (i.e. the real program event time is the real broadcasting time which the program segment 133 is displayed plus 31:01). Finally, the program event is transmitted to the client at the correct real program event time.

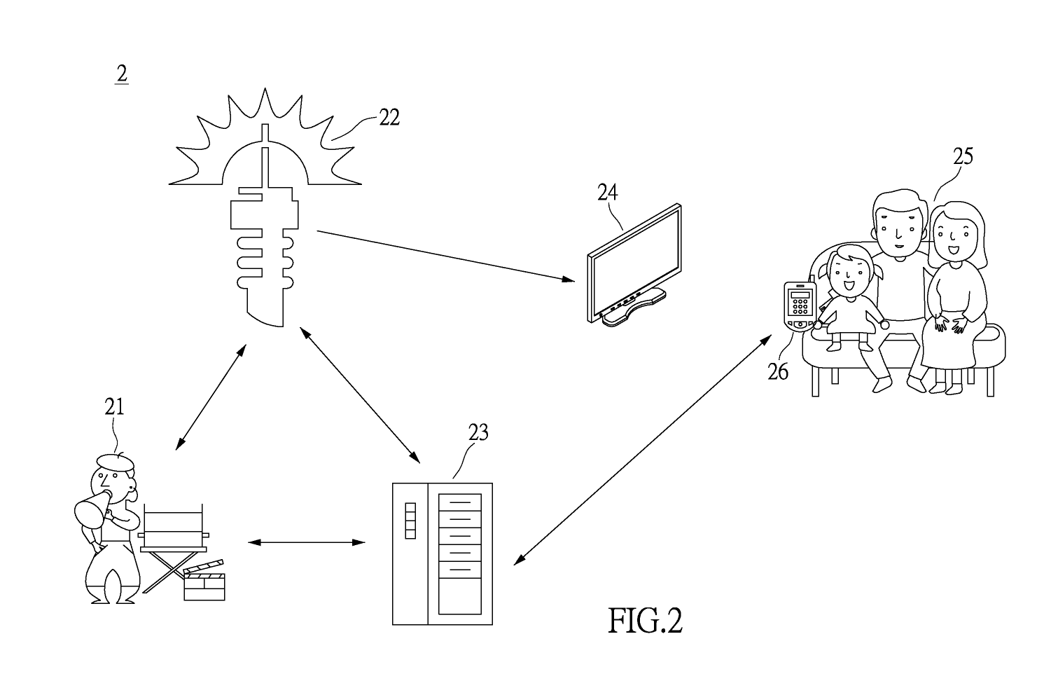

Referring to FIG. 2, FIG. 2 is a schematic diagram showing system architecture of a program data transmission system according to an exemplary embodiment of the present disclosure. The system architecture of the program data transmission system according to an exemplary embodiment of the present disclosure is illustrated with details as follows. The program data transmission system 2 comprises a server of a program maker end 21, a server of a television station end 22, a server of a service provider end 23, a displaying and playing device 24 (such as a television of any kind, and the present disclosure is not limited thereto) of a client end 25, and a networking device 26 (such as a smart phone or a tablet computer, and the present disclosure is not limited thereto). The server of the television station end 22 is linked to the server of the program maker end 21 and the server of the service provider end 23, and the server of the program maker end 21 is linked to the server of the service provider end 23. The displaying and playing device 24 of the client end 25 is linked to the server of the television station end 22, and the networking device 26 of the client end 25 is linked to the server of the service provider end 23.

The program maker end 21 may post-process the recorded video and audio data through the server thereof to generate a program, and the segments the program to generate several program segments. The server of the program maker end 21 transmits the program with the program segments to the server of the television station end 22, and indicates the television station end 22 the lengths of the program segments, that is, the original times of the program segments are known by the television station end 22. The program maker end 21 can determine the program event and the program event time before the program is broadcasted, and the determined program event and the program event time are recorded in an event database of the server of the program maker end 21.

The server of the television station end 22 inserts multiple advertisements between the program segments, and determines the real broadcasting time and the channel of the program with inserted advertisements, wherein the relations between the real broadcasting time, the channel, and the program data with inserted advertisements are recorded in the program database of the server of the television station end 22 as a program data. The program data may comprise video and audio data of the program segments, an actual program broadcasting time, and a channel. The server of the television station end 22 transmits the program data to the displaying and playing device 24 of the client end 25. The displaying and playing device 24 of the client end 25 is used to display the program with inserted advertisements.

Next, the server of the television station end 22 or the program maker end 21 may mark features on the frontend parts of the program segments (such as embedding the digital watermarks into the frontend parts of the program segments) or extract features of the frontend parts associated with the program segments (such as extracting audio fingerprints of the frontend parts associated with the program segments), and record the relation between the features and program segments in a feature database thereof. The relation between the features and program segments conveys information of original times of the program segments corresponding to the features.

The server of the service provider end 23 receives the program data from the program database, the program event and the program event time from the event database, and detects the features of the frontend parts associated with the program segments according to the video and audio data of the program segments. When the features of the frontend parts associated with the program segments are detected by the server of the service provider end 23, the server of the service provider end 23 queries the feature database to find how the features correspond to the program segments, such that the original times of the program segments corresponding to the detected features can be obtained. After the original times of the program segments are obtained, the server of the service provider end 23 can determine a relation between the original times of the program segments and the program displaying times of the program segments according to the original times of the program segments and program displaying times of the program segments. Then, the server of the service provider end 23 can calculate a real program event time of the program event according to a real broadcasting time of the program data, the program event time, and the relation between the original times of the program segments and the program displaying times of the program segments. Next, the server of the service provider end 23 transmits the program event to the networking device 26 of the client end 25 at the real program event time.

It is noted that though the server of television station end 22 transmits the program with inserted advertisements directly to the displaying and playing device 24 of the client end 25 in the exemplary embodiment, the person with ordinary skill in the art can understand that the server of the television station end 22 may transmit program with inserted advertisements to the displaying and playing device 24 of the client end 25 through the server of the service provider end 23 in another one exemplary embodiment (meanwhile, the displaying and playing device 24 of the client end 25 is linked to the server of the service provider end 23). In addition, the person with ordinary skill in the art can understand the displaying and playing device 24 and the networking device 26 of the client end 25 may be integrated into one smart television. In short, the system architecture of the program data transmission system shown in FIG. 2 is not used to limit the present disclosure.

In the program data transmission system 2, since the server of the service provider end 23 can detect the features of the frontend parts associated with the program segments to obtain the relation between the original times of the program segments and the program displaying times of the program segments, the program maker end 21 can still use the original times of the program segments to mark the program event on the program event time, i.e. the program event time is not influenced by the inserted advertisements. In addition, the program maker end 21 can determine the program event and the program event time before the program is displayed without determining them early. Thus, if the program event is an advertisement event, the charge of the advertisement can wait for a good price, and the business value of the program event can be increased.

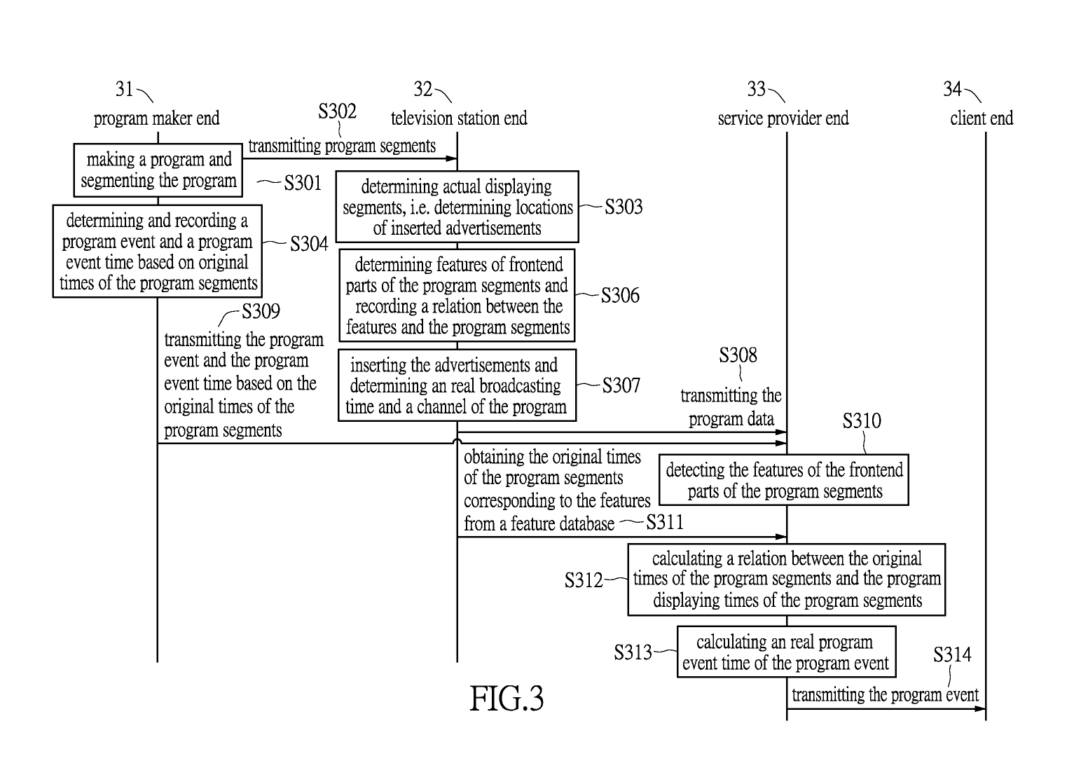

Referring to FIG. 3, FIG. 3 is a flow chart of a program event detection method according to an exemplary embodiment of the present disclosure. The steps of the program event detection method can be implemented by a software, firmware, or hardware with one or more circuits, and the codes of the program event detection method can be stored in a non-volatile computer readable medium.

At step S301, the program maker end 31 makes a program and segments the program through the server thereof to generate program segments. Next, at step S302, the server of the program maker end 31 transmits the program with the program segments to the server of the television station end 32. At step S303, television station end 32 determines the actual displaying segments through the server thereof, i.e. determining the locations of the inserted advertisements.

At steps S304, the program maker end 31 determines the program event and the program event time of the program event based on the original times of the program segments, and records the program event and the program event time in an event database. Step S304 can be executed before the step S310 is executed, i.e. before the real broadcasting time of the program with inserted advertisements reaches. Though step S304 in FIG. 3 is executed before step 306 is executed and after steps S302 is executed, the present disclosure is not limited thereto.

Next, at step S306, the server of the television station end 32 determines the features of the frontend parts associated with the program segments, and records the relation between the features and the program segments in the feature database. The determination of the features of the frontend parts associated with the program segments is implemented by embedding the known digital watermarks in the frontend parts of the program segments or extracting audio fingerprints of the frontend parts associated with the program segments. At step S307, the server of the television station end 32 inserts the advertisements between the program segments, to generate a program with inserted advertisements, and determine the real broadcasting time and the channel of the program with inserted advertisements. The relation between the real broadcasting time, the channel, and the program with inserted advertisements is stored in the program data base of the server of the television station end 32 as the program data.

At step S308, the server of the television station end 32 transmits the program data in the program data base to the server of the service provider end 33. At step S309, the server of the program maker end 31 transmits the program event and a program event time to the service provider end 33.

At step S310, the server service provider end 33 obtains the video and audio data of the program segments from the program, and detects features of frontend parts associated with the program segments. At step S311, the server of the service provider end 33 queries the feature database to find how the features correspond to the program segments, such that the server of the service provider end can obtain the original times of the program segments corresponding to the detected features.

At step S312, the server of the service provider end 33 determines the relation between the original times of the program segments and the program displaying times of the program segments. Next at steps S313, the server of the service provider end 33 calculates a real program event time of the program event according to a real broadcasting time of the program data, the program event time, and the relation between the original times of the program segments and the program displaying times of the program segments. Finally, at step S314, the server of the service provider end 33 transmits the program event to a networking device of a client end 34 at the real program event time. Therefore, the program event can be presented to the client end at the real program event time.

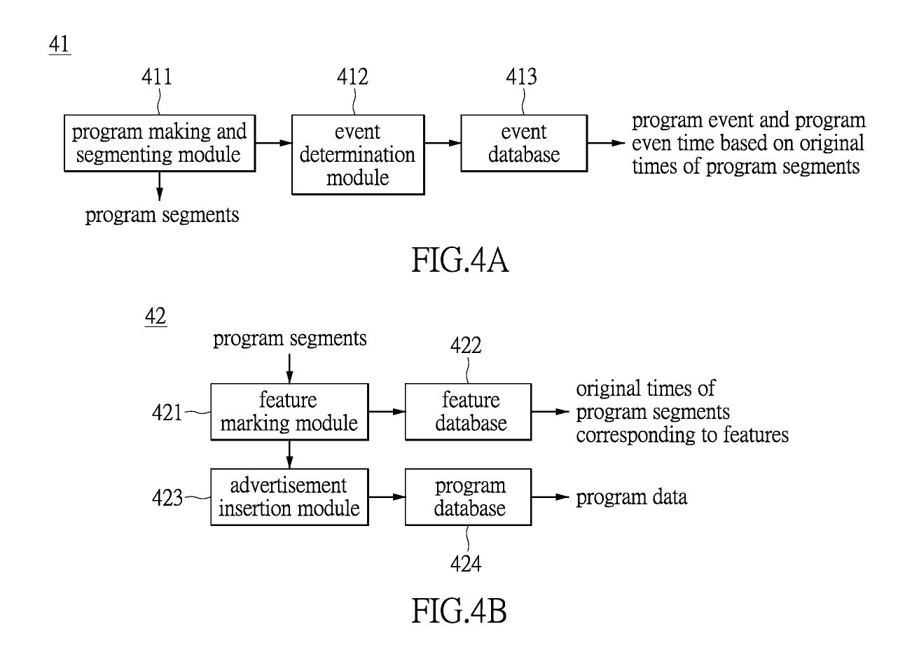

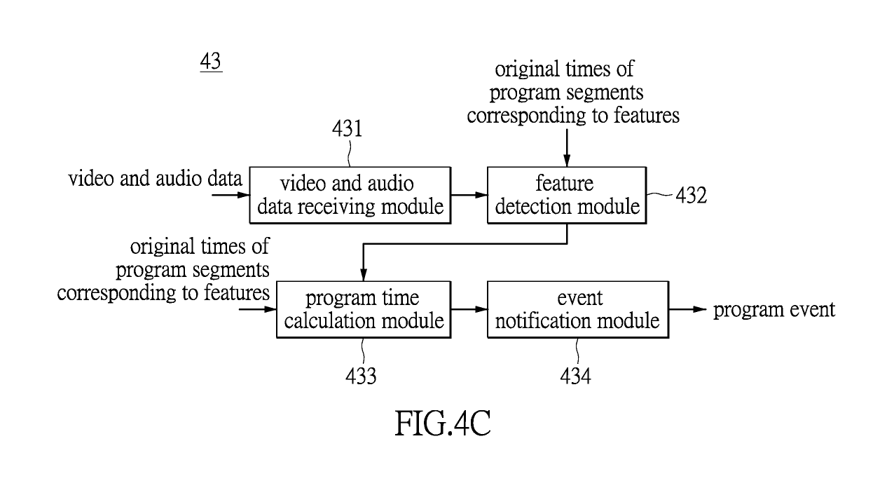

The details of the server of the program maker end 31 for implementing the program event detection method of FIG. 3 are illustrated as follows. Referring to FIG. 4A, FIG. 4A is a block diagram of a server of a program maker end for implementing the program event detection method of FIG. 3. In the exemplary embodiment, the server 41 of the program maker end comprises a program making and segmenting module 411, an event determination module 412, and an event database 413, wherein the program making and segmenting module 411 is electrically connected to the event determination module 412, and the event determination module 412 is electrically connected to the event database 413.

The program making and segmenting module 411 is used to post-process the recorded video and audio data to generate the program, and segment the program to output the program with program segments. The event determination module 412 is provided to the program maker end. Thus the program maker end can operate the event determination module 412 to determine the program event and the program event time based on the original times. The event database 413 is used to record and output the program event and the program event time based on the original times.

The details of the server of the television station end 32 for implementing the program event detection method of FIG. 3 are illustrated as follows. Referring to FIG. 4B, FIG. 4B is a block diagram of a server of a television station end for implementing the program event detection method of FIG. 3. In the exemplary embodiment of the present disclosure, the server 42 of the television station end comprises a feature marking module 421, a feature database 422, an advertisement insertion module 423 and a program database 424, wherein the feature marking module 421 is electrically connected to the feature database 422 and the advertisement insertion module 423, and the program database 424 is electrically connected to the advertisement insertion module 423.

The feature marking module 421 is used to determine the features of the frontend parts associated with the program segments, wherein the determination of the features of the frontend parts associated with the program segments is mentioned above without repeating the descriptions again. The feature database 422 is used to record the relation between the features and the program segments, and output the original times of the program segments corresponding to the features. The insertion module 423 is used to insert the advertisements between the program segments or the processed program segments (which frontend parts are embedded with the digital watermarks) to generate the program with inserted advertisements, and determine the real broadcasting time and the channel of the program with inserted advertisements. The program database 424 stores the real broadcasting time, the channel, and the program with inserted advertisements as the program data, and outputs the program data.

The details of the server of the service provider end 33 for implementing the program event detection method of FIG. 3 are illustrated as follows. Referring to FIG. 4C, FIG. 4C is a block diagram of a server of a service provider end for implementing the program event detection method of FIG. 3. In the exemplary embodiment of the present disclosure, the server 43 of the service provider end comprises a video and audio data receiving module 431, a feature detection module 432, a program time calculation module 433, and an event notification module 434, so as to form the program event detection apparatus of the exemplary embodiment in the present disclosure. The video and audio data receiving module 431 is electrically connected to the feature detection module 432, the feature detection module 432 is electrically connected to the program time calculation module 433, and the program time calculation module 433 is electrically connected to the event notification module 434.

The video and audio data receiving module 431 is used to receive the video and audio data of the program segments. The feature detection module 432 detects the features of the frontend parts of the program segments received by the video and audio data receiving module 431, and obtains the original times of the program segments corresponding to the features. The program time calculation module 433 receives the program event and the program event time based on the original times of the program segments, determine the relation between the original times of the program segments and the program displaying times of the program segments, and calculates the real program event time of the program event according to an real broadcasting time of the program data, the program event time, and the relation between the original times of the program segments and the program displaying times of the program segments. The event notification module 434 transmits the program event to the networking device of the client end at the real program event time.

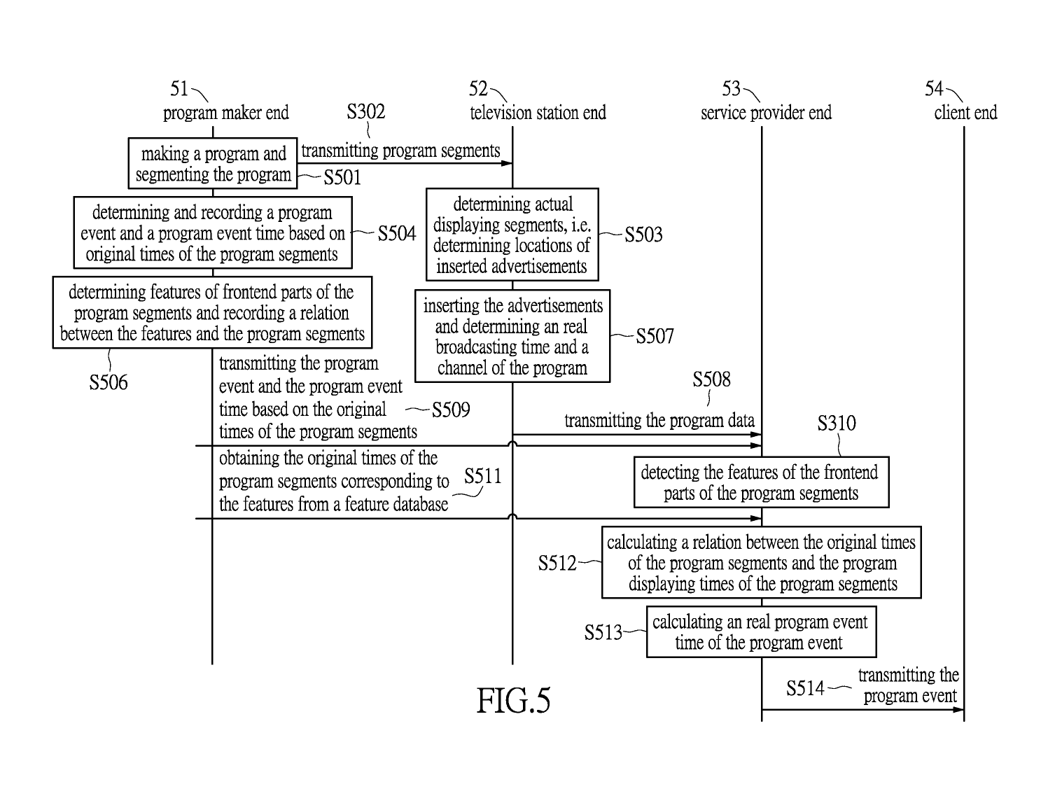

Referring to FIG. 5, FIG. 5 is a flow chart of a program event detection method according to another one exemplary embodiment of the present disclosure. The program event detection method in FIG. 5 can also make the client end receive the program event at the correct real program event time, and the difference between the program event detection method in FIG. 3 and FIG. 5 is that the features of the frontend parts associated with the program segments is are determined by the server of the program maker end 51 server rather than the server of the television station end 52. The steps S501, S502, S504, S506, and S509 executed by the server of the program maker end 51 in FIG. 5 are respectively the same as the steps S301, S302, S304, S306, and S309 in FIG. 3. The steps S503, S507, and S508 executed by the server of the television station end 52 in FIG. 5 are respectively the same as the steps S303, S307, and S308 in FIG. 3. The steps S510 through S514 executed by the server of the service provider end 53 in FIG. 5 are respectively the same as the steps S310 through 314 in FIG. 3. Therefore, the redundant descriptions are omitted.

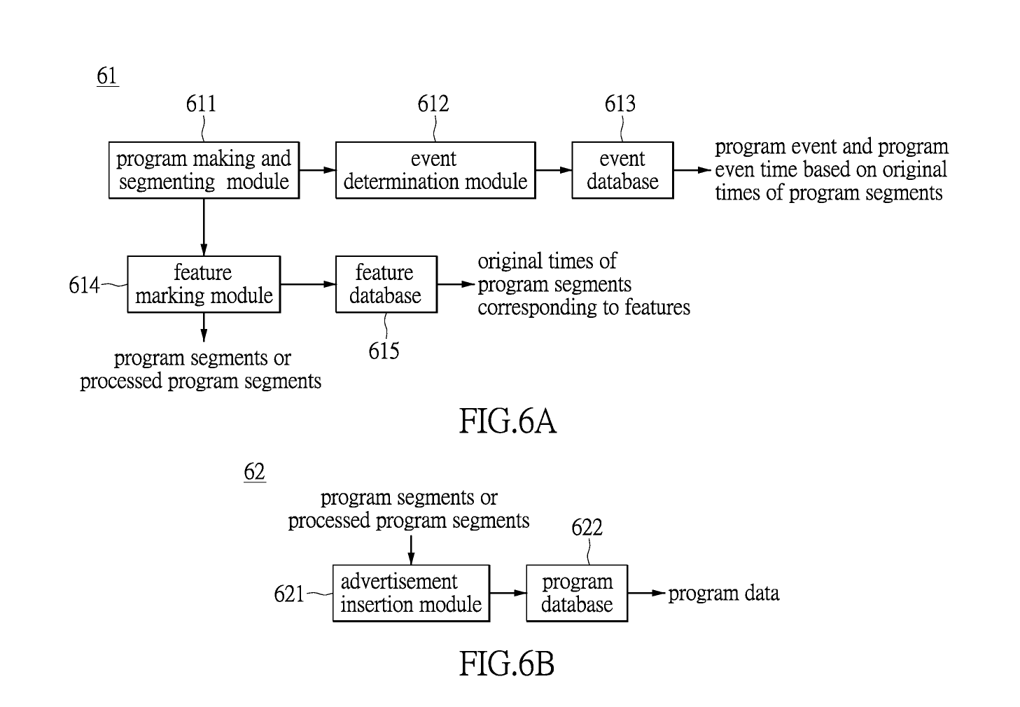

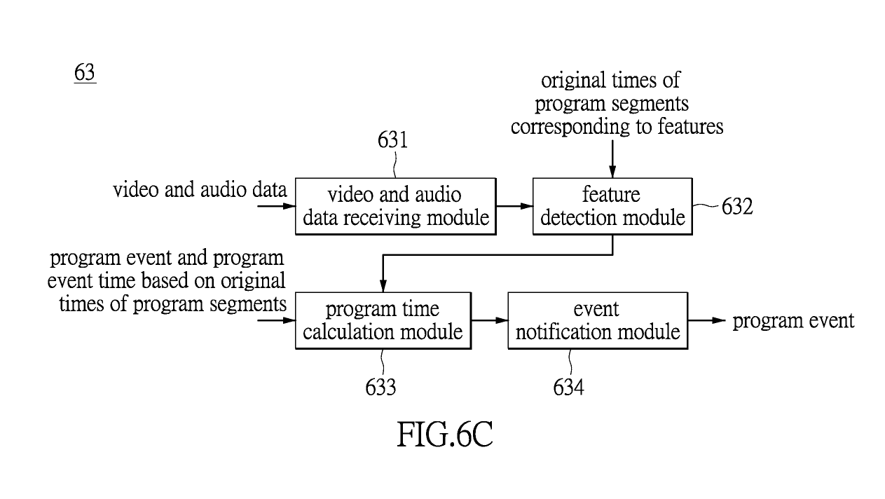

The details of the server of the program maker end 51 for implementing the program event detection method of FIG. 5 are illustrated as follows. Referring to FIG. 6A, FIG. 6A is a block diagram of a server of a program maker end for implementing the program event detection method of FIG. 5. In the exemplary embodiment of the present disclosure, the server 61 of the program maker end comprises a program making and segmenting module 611, an event determination module 612, an event database 613, a feature marking module 611, and a feature database 615, wherein the program making and segmenting module 611 is electrically connected to the event determination module 612 and the feature marking module 614, the event determination module 612 is electrically connected to the event database 613, and the feature database is electrically connected to the feature marking module 615. In FIG. 6A, the program making and segmenting module 611, the event determination module 612, the event database 613, the feature marking module 611, and the feature database 615 are respectively the same as the program making and segmenting module 411, the event determination module 412, event database 413 in FIG. 4A, the feature marking module 421, and the feature database 422 in FIG. 4B, thus omitting the redundant descriptions.

The details of the server of the television station end 52 for implementing the program event detection method of FIG. 5 are illustrated as follows. Referring to FIG. 6B, FIG. 6B is a block diagram of a server of a television station end for implementing the program event detection method of FIG. 5. In the exemplary embodiment of the present disclosure, the server 62 of the television station end comprises an advertisement insertion module 621 and a program database 622, wherein the advertisement insertion module 621 is electrically connected to the program database 622. In FIG. 6B, the advertisement insertion module 621 and the program database 622 are respectively the same as the advertisement insertion module 423 and the program database 424 in FIG. 4B, thus omitting the redundant descriptions.

The details of the server of the service provider end 53 for implementing the program event detection method of FIG. 5 is illustrated as follows. Referring to FIG. 6C, FIG. 6C is a block diagram of a server of a service provider end for implementing the program event detection method of FIG. 5. In the exemplary embodiment of the present disclosure, the server 63 of the service provider end comprises a video and audio data receiving module 631, a feature detection module 632, a program time calculation module 633, and an event notification module 634, to form the program event detection apparatus of the exemplary embodiment in the present disclosure. In FIG. 6C, the video and audio data receiving module 631, the feature detection module 632, the program time calculation module 633, and the event notification module 634 are respectively the same as the video and audio data receiving module 431, the feature detection module 432, the program time calculation module 433, and the event notification module 434 in FIG. 4C, thus omitting the redundant descriptions.

Accordingly, the program event detection method, apparatus, and the program data transmission system provided by exemplary embodiments of the present disclosure can make the program event time based on the original times be not influenced by the inserted advertisements, and further let the not to determine the program event and program event time early, such that the business value of the program event can be increased. In addition, the implementation complexities of the program event detection method, apparatus, and the program data transmission system are not high, such that the costs are increased little.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A program event detection method, mainly executed in a server of a service provider end, comprising:
detecting a plurality of features of frontend parts associated with program segments in a program data;
obtaining original times of the program segments corresponding to the features from a feature database;
according to the original times of the program segments and program displaying times of the program segments, determining a relation between the original times of the program segments and the program displaying times of the program segments;
receiving a program event and a program event time of the program event based on the original times of the program segments;
according to a real broadcasting time of the program data, the program event time, and the relation between the original times of the program segments and the program displaying times of the program segments, calculating a real program event time of the program event; and
at the real program event time, transmitting the program event to a networking device.

2. The program event detection method according to claim 1, wherein the features of the frontend parts associated with the program segments are a plurality of digital watermark embedded into the frontend parts of the program segments.

3. The program event detection method according to claim 1, wherein the features of the frontend parts associated with the program segments are a plurality of audio fingerprints associated with the frontend parts of the program segments.

4. The program event detection method according to claim 1, further comprising steps executed in a server of a program maker end or a television station end as follows:
determining the features of the frontend parts associated with the program segments, and recoding a relation between the features and the program segments in a feature database.

5. The program event detection method according to claim 4, further comprising steps executed in the server of the program maker end as follows:
before the real broadcasting time of the program data reaches, determining the program event and the program event time, and recording the program event and the program event time in an event database.

6. The program event detection method according to claim 4, further comprising steps executed in the server of the television station end as follows:
receiving the program data having the program segments from the program maker end, and inserting advertisements between the program segments; and
determining the real broadcasting time and a channel of the program data, and recording the program data in the program database.

7. A program event detection apparatus, comprising:
a feature detection module, used to detect features of frontend parts associated with program segments in a program data, and obtain original times of the program segments corresponding to the features from a feature database;
a program time calculation module, electrically connected to the feature detection module, used to receive a program event and a program event time based on the original times of the program segments, determine a relation between the original times of the program segments and the program displaying times of the program segments according to the original times of the program segments and program displaying times of the program segments, and calculate a real program event time of the program event according to a real broadcasting time of the program data, the program event time, and the relation between the original times of the program segments and the program displaying times of the program segments; and
an event notification module, electrically connected to the program time calculation module, used to transmit the program event to a networking device of a client end at the real program event time.

8. The program event detection apparatus according to claim 7, wherein the features of the frontend parts associated with the program segments are a plurality of digital watermark embedded into the frontend parts of the program segments.

9. The program event detection apparatus according to claim 7, wherein the features of the frontend parts associated with the program segments are a plurality of audio fingerprints associated with the frontend parts of the program segments.

10. A program data transmission system, comprising:
a server of a program maker end, used to determine a program event and a program event time, and record the program event and the program event time in an event database before a real broadcasting time of a program data reaches;
a server of a television station end, linked to the server of the program maker end, used to receive the program data having the program segments from the program maker end, insert advertisements between the program segments, determine a real broadcasting time and a channel of the program data, and record the program data in the program database; and
a server of a service provider end, linked to the server of the program maker end and the server of the television station end, used to detect features of frontend parts associated with the program segments in the program data, obtain original times of the program segments corresponding to the features from a feature database, determine a relation between the original times of the program segments and the program displaying times of the program segments according to the original times of the program segments and program displaying times of the program segments, receive a program event and a program event time based on the original times of the program segment, calculate a real program event time of the program event according to a real broadcasting time of the program data, the program event time, and the relation between the original times of the program segments and the program displaying times of the program segments, and transmit the program event to a networking device of a client end at the real program event time;
wherein the server of the program maker end or the server of the television station end is further used to determine the features of the frontend parts associated with the program segments, and record a relation between the features and the program segments in a feature database.
